(19) United States
(12) Patent Application Publication
(10) Pub. No.: US 2007/0183705 A1
(43) Pub. Date: Aug. 9, 2007

(54) Bearing retention clamp

(76) Inventors: Larry W. Delaney, Owosso, MI (US); Bernard Ruban Gnanasigamani, Owosso, MI (US)

Correspondence Address: JAECKLE FLEISCHMANN & MUGEL, LLP, 190 Linden Oaks, ROCHESTER, NY, 14625-2812, US

(21) Appl. No.: 11/351,124

(22) Filed: Feb. 9, 2006

(51) Int. Cl. F16C 43/00

(52) U.S. Cl. 384/537

(57) ABSTRACT

An armature is limited in its axial movement by a pair of retainer clamps positioned over a bearing that has been press fitted onto the shaft of the armature. The clamps are first secured by bolts through an end cap onto lower surfaces in first recessed regions in the end cap in an orientation to allow insertion of the bearing into the bearing bore of the end cap. The motor is then assembled preventing further direct access to the clamps. After assembly the clamps are first loosened so that they are no longer secured to the surfaces. Next, the bolts are turned in a clockwise direction which first turns the clamps until they hit a vertical wall in the end cap which orients the clamps partially over the bearing, and then the clamps tighten onto the lower surfaces of second recessed regions.

### TECHNICAL FIELD

The present invention relates in general to a bearing retention clamp, and, more particularly, to a bearing retention clamp for use in permanent magnet DC motors.

### BACKGROUND OF THE INVENTION

The armature of an electric motor is susceptible to unwanted axial movement, especially in environments which cause the motor to vibrate excessively. Several methods have been used in the past to reduce this axial movement.

One of these methods is to place a preload spring in the casting bore that receives the end of the armature opposite the commutator end of the armature (the opposite-comm.-end) to make up for the internal tolerances and prevent axial movement of the armature, and to apply Loctite® to the opposite-comm.-end bearing to lock the armature in place. Another method is to use a retainer plate to capture the comm.-end bearing. This method uses the following assembly steps: a) slip fit the bearing into the comm.-end casting bore; b) press fit the armature into the bearing; c) turn the casting-armature assembly upside down; d) screw the retainer plate to the casting; and e) place a preload washer on the opposite-comm.-end casting to take up the internal tolerances. A third method uses the orbit-form process to capture the comm.-end bearing. The assembly steps for this method are the following: a) slip fit the bearing into the comm.-end casting bore; b) using the orbit-form tool, form the lipped-protrusion of the casting bore over the bearing to capture it in place; c) press fit the armature assembly into the bearing; and d) place a preload washer on the opposite-comm.-end casting to take up the internal tolerances.

However, in all these methods, since the bearings are locked in place to the end cap casting in an effort to prevent the axial movement of the armature, the alignment of the bearings' inner & outer races in the free and loaded condition of the motor is restricted. In many cases, this creates an objectionable bearing noise during the motor operation.

It is a principal object of the present invention to provide a bearing retention method that does not restrict the bearings' inner and outer races to align themselves in the free and loaded condition of the motor.

### SUMMARY OF THE INVENTION

Briefly described is a method of positioning a bearing retention clamp by first securing the bearing retention clamp with a bolt to a surface in a recessed area in an end cap, the recessed area being contiguous with a bearing bore in the end cap. Next, inserting a bearing into the bearing bore, loosening the clamp from the surface; and then turning the bolt to tighten the clamp whereby the clamp is turned to a position to partially extend over the bearing.

Also described is a bearing retention clamp receiving region in an end cap having a first recessed region contiguous to a bearing bore in the end cap and a second recessed region positioned at least partially within the first recessed region with the second recessed region recessed with respect to the first recessed region.

Additionally described is a bearing retention clamp apparatus with a bearing retention clamp receiving region in an end cap having a first recessed region contiguous to a bearing bore in the end cap and a second recessed region positioned at least partially within the first recessed region with the second recessed region recessed with respect to the first recessed region. The bearing retention clamp is of a size that can fit in both the first recessed region and the second recessed region and a bolt extends through the end cap that is screwed into the bearing retention clamp.

### BRIEF DESCRIPTION OF THE DRAWINGS

These and other features and advantages of the invention will be more fully understood and appreciated from the following description of a certain exemplary embodiment of the invention taken together with the accompanying drawings, in which:

FIG. 1 is a side view of an armature with the axial bearings which can be used with one embodiment of the present invention;

FIG. 2 is a top view of a bottom end cap casting used is one embodiment of the present invention;

FIG. 3 is a more detailed view of a portion of the casting of FIG. 2;

FIG. 4 is a first perspective view of a portion of the casting of FIG. 2;

FIG. 5 is a second perspective view of a portion of the casting of FIG. 2;

FIG. 6 is a top view of a portion of the bottom end cap casting of FIG. 2 with a bearing retention clamp that is in a first position;

FIG. 7 is a perspective view of a motor which includes an embodiment of the present invention;

FIG. 8 is a top view of a portion of the bottom end cap casting of FIG. 2 with the bearing retention clamp in a second position;

FIG. 9 is a perspective view of a portion of the bottom end cap casting of FIG. 2 with the bearing retention clamp in a third position;

FIG. 10 is a perspective view of the casting of FIG. 2 with the armature of FIG. 1 in place and the bearing retention clamp in the first position;

FIG. 11 is FIG. 10 with the bearing retention clamp in the third position; and

FIG. 12 is a cross section of the structure of FIG. 10.

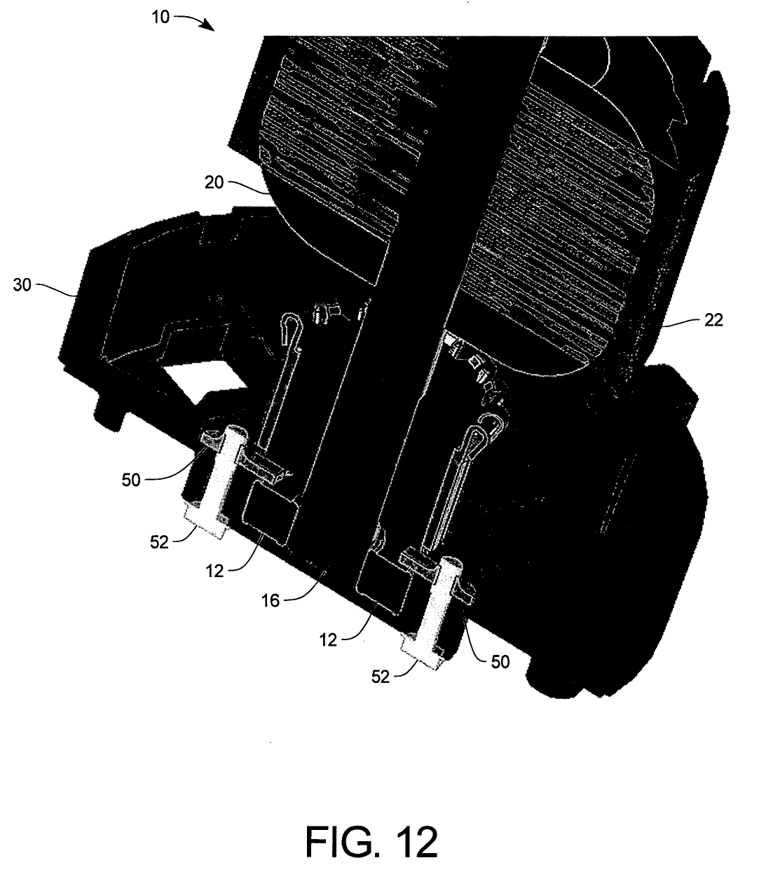

It will be appreciated that for purposes of clarity and where deemed appropriate, reference numerals have often been repeated in the figures to indicate corresponding features, and that the various elements in the drawings have not necessarily been drawn to scale in order to better show the features of the invention.

### DESCRIPTION OF THE PREFERRED EMBODIMENTS

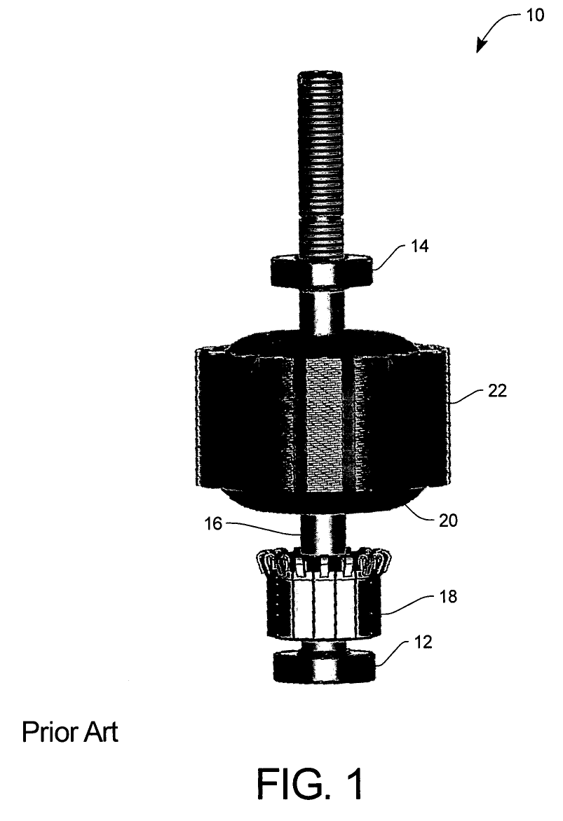

Turning now to the drawings, FIG. 1 is a side view of an armature 10 with comm.-end and opposite-comm.-end bearings 12 and 14, respectively. The armature 10 has a shaft 16 attached to a commutator 18 and has electrical windings 20 with laminated bars 22 that are partially embedded in the electrical windings 20. The bearings 12 and 14 are press fitted onto the shaft 16.

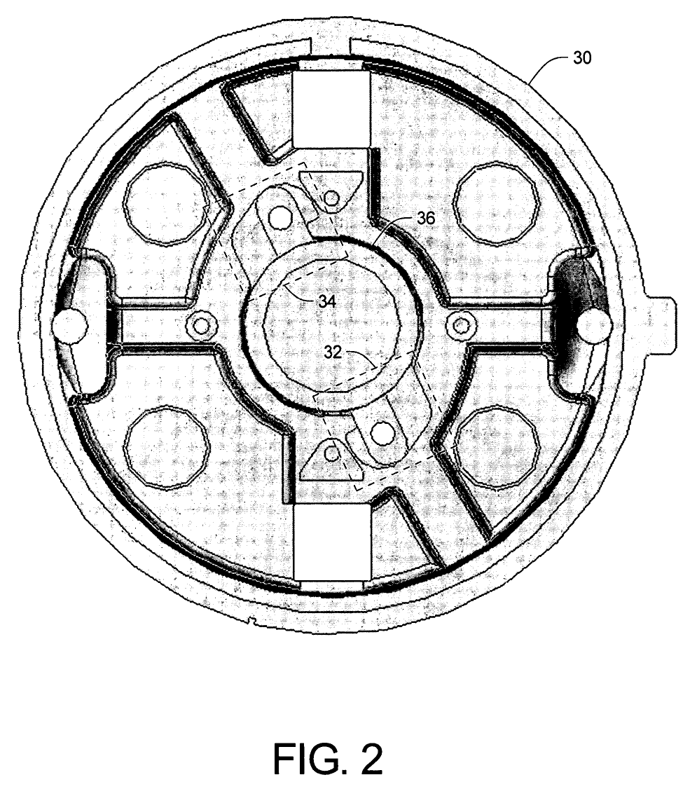

FIG. 2 is a top view of a bottom end cap casting 30 used is one embodiment of the present invention. The casting 30 has two identical structures 32 and 34 formed next to the bearing bore 36 of the casting 30.

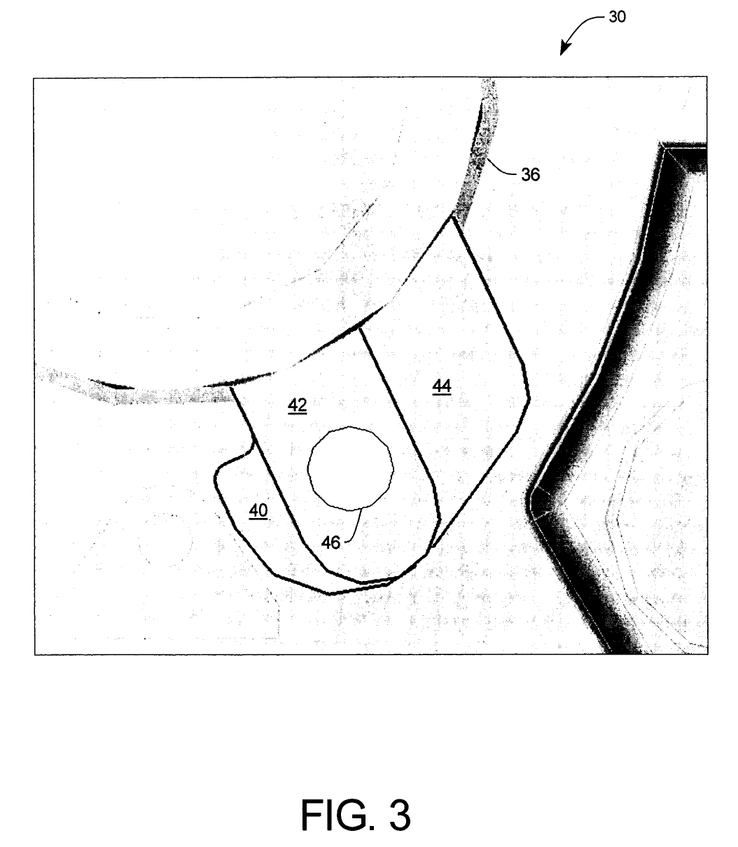

FIG. 3 is a more detailed view of the structure 32 showing three regions 40, 42 and 44. A hole 46 is located in region 42.

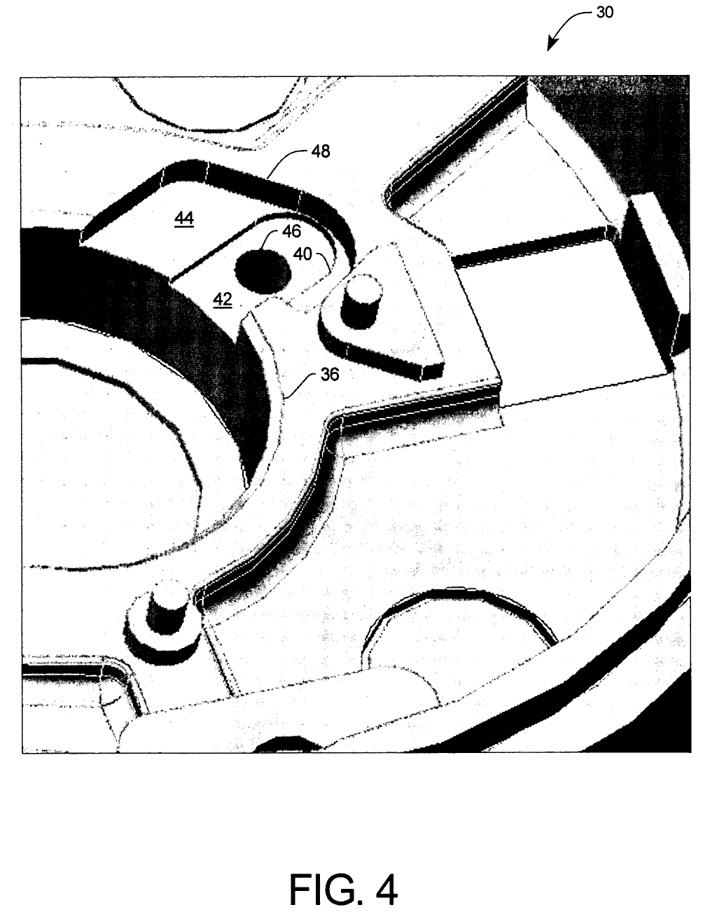

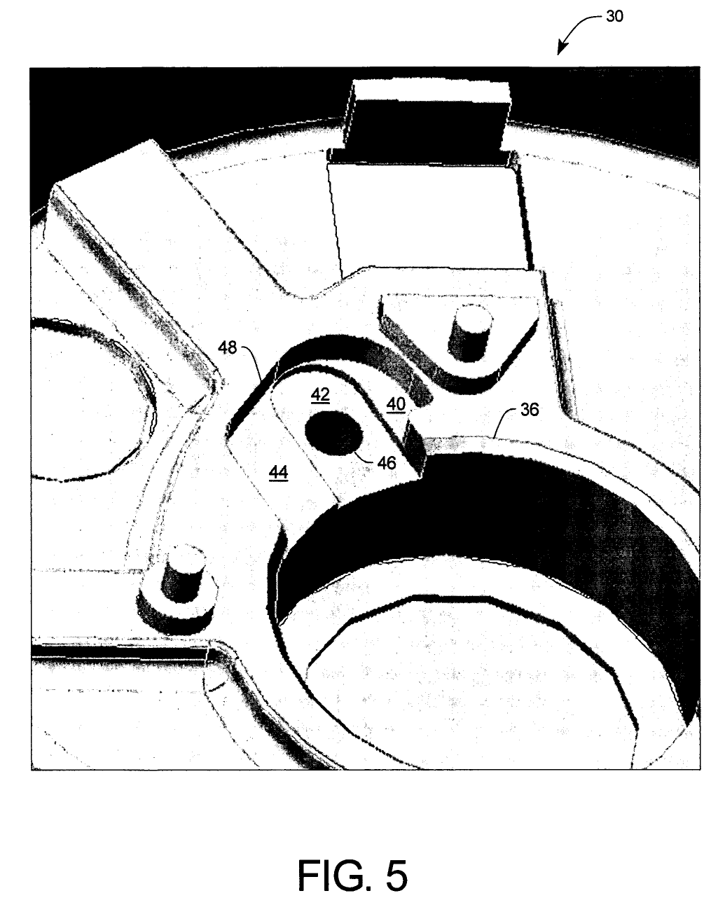

FIGS. 4 and 5 are perspective views of a portion of the casting of FIG. 2 showing the relative depth of the regions 40, 42, and 44. As can be seen the regions 40 and 44 are at the same depth which is below the immediate surrounding surface 48 of the three regions 40, 42, and 44. In the preferred embodiment the regions 40 and 44 have a depth of 0.1 inches below the surrounding region 48, and region 42 has a depth of 0.03 inches below regions 40 and 44.

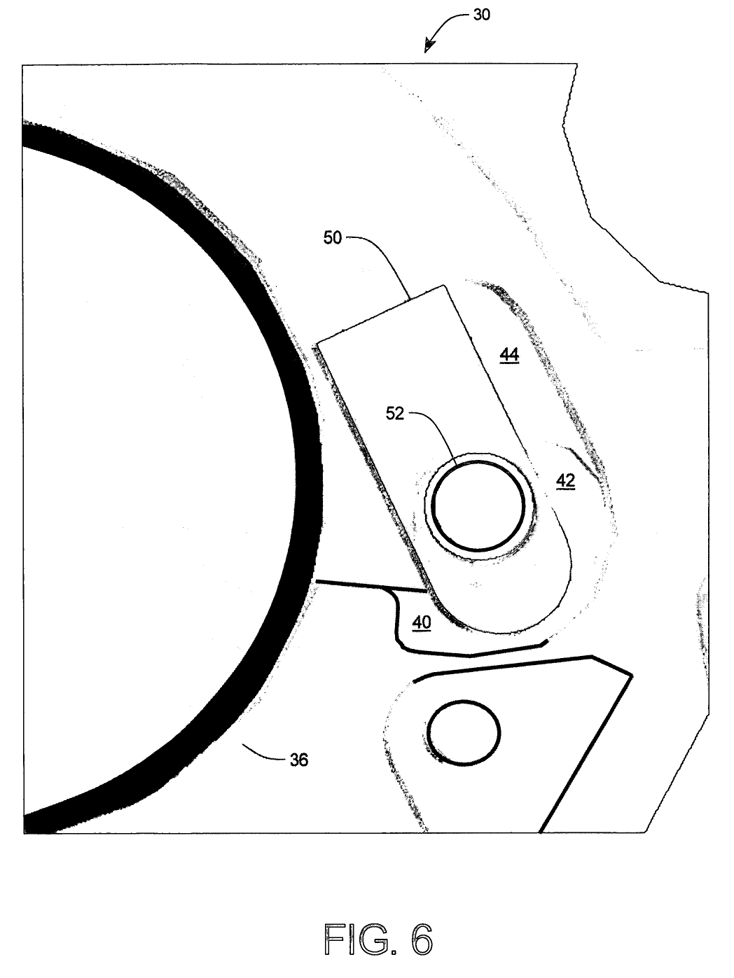

Turning now to FIG. 6, during assembly of the motor a bearing retention clamp 50 is tightened by a screw 52 to lie across regions 40 and 44 in a first position shown in FIG. 6 prior to the insertion of the armature 10 into the bearing bore 36. In the preferred embodiment the screw 52 has an interference thread. In the preferred embodiment the bearing retention clamp 50 is held in the first position by an assembly fixture and the screw 52 is tightened to 5 in-lbs. After the bearing retention clamp 50 is in the first position as shown in FIG. 6, the rest of the motor is assembled which also includes placing a preload washer on top of the bearing 14.

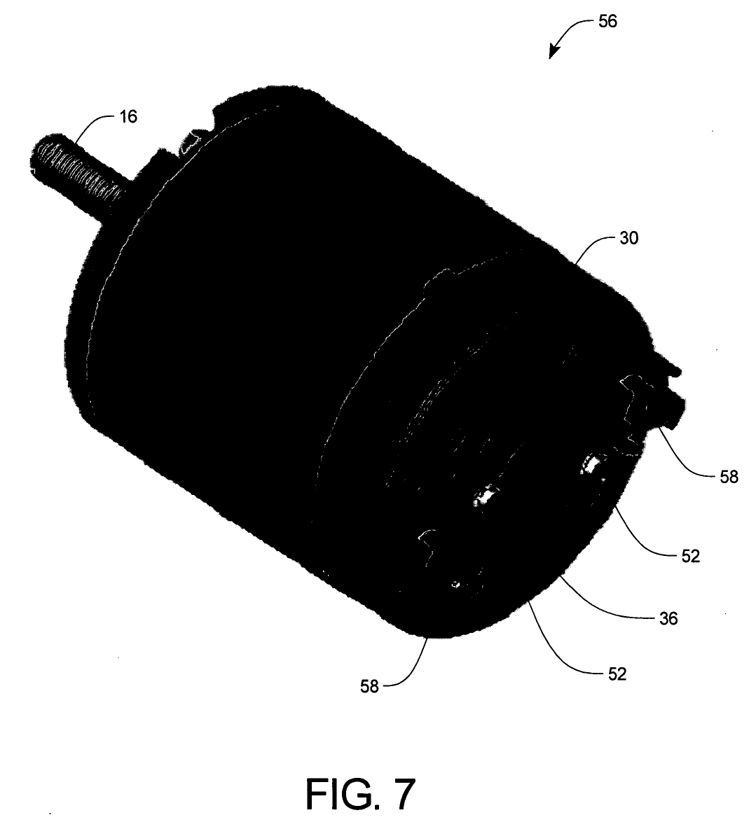

FIG. 7 is a perspective view of the assembled motor 56 showing the bolts 52 and two electrical terminals 58. At this time the bearing retention clamp 50 is not directly accessible since it is covered by the motor housing. The following describes the procedure used to position the bearing retention clamp 50 to retain the bearing 12 in the bearing bore 36 to thereby restrict the axial movement of the armature 10 without restricting the inner and outer races of the bearing 12 from aligning themselves in the free and loaded conditions of the motor.

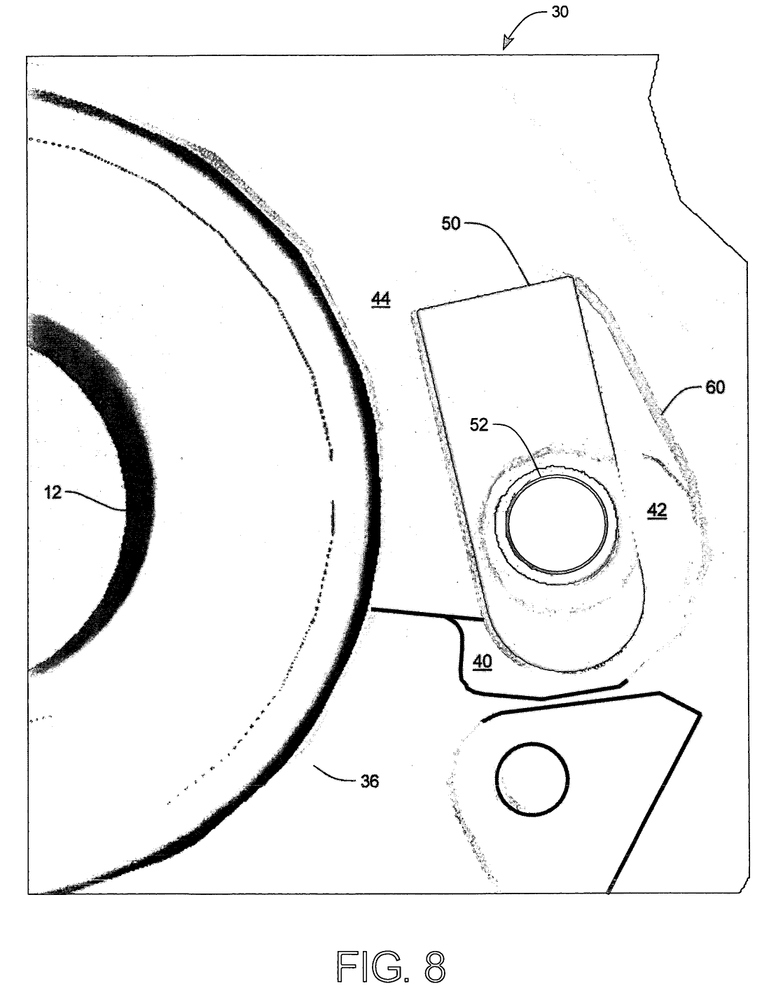

FIG. 8 is a top view of a portion of the bottom end cap casting 30 of FIG. 2 with the bearing 12 in the bearing bore 36 and the bearing retention clamp 50 in a second position. This drawing is for instructional purposes only since, as described above, once the bearing 12 that has been interference fitted onto the shaft 16 and the rest of the motor are assembled, the bearing retention clamp 50 is not directly accessible. In FIG. 8 the bearing 12 is in the bearing bore 36, and the bearing retention clamp 50 has been loosened by turning the screw 52 1½ turns in the preferred embodiment so that it is not clamped to the surfaces 40 and 44. The 1½ turns loosens the bearing retention clamp 50 from the surfaces 40 and 44 and, due, in part, to the interference thread on the screw 52, the bearing retention clamp 50 rotates to a second position against a vertical wall 60 that is the outer radial boundary of the surface 44. The bearing retention clamp 50 remains in the second position even if the 1½ turns of the screw 52 have not been completed before the bearing retention clamp 50 contacts the wall 60.

After the 1½ turns have been completed, the screw 52 is rotated clockwise which causes the bearing retention clamp 50 to rotate to a third position.

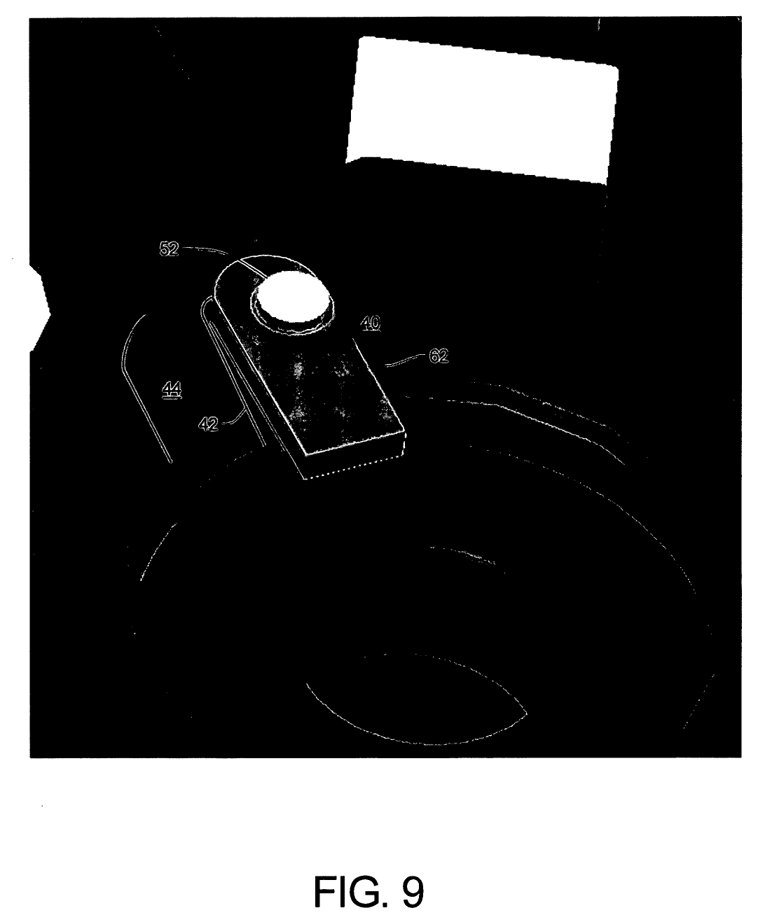

FIG. 9 shows the bearing retention clamp 50 in the third position that is over the bearing 12 and the surface 42. The vertical wall 62, which is next to the region 42, prevents the bearing retention clamp 50 from turning any more and the subsequent turning of the screw 52 causes the bearing retention clamp 50 to clamp against the lower surface of the region 42, the bearing 12 lying below the surface 42. In this position the clamping of the bearing 12 restricts the axial movement of the armature 10. In the preferred embodiment the screw 52 is torqued to 20 in-lbs, and the number of rotations of the screw 52 is monitored to insure that the bearing retention clamp 50 is in the correct position. The clamp settling into the region 42 requires more turns of the screw 52 than if regions 40, 42, and 44 were combined into a single region, and therefore, by counting the number of revolutions of the screw 52, it can be determined if the clamp has settled into the region 42 or has tightened on region 44 indicating that the bearing retention clamp 50 is not correctly positioned.

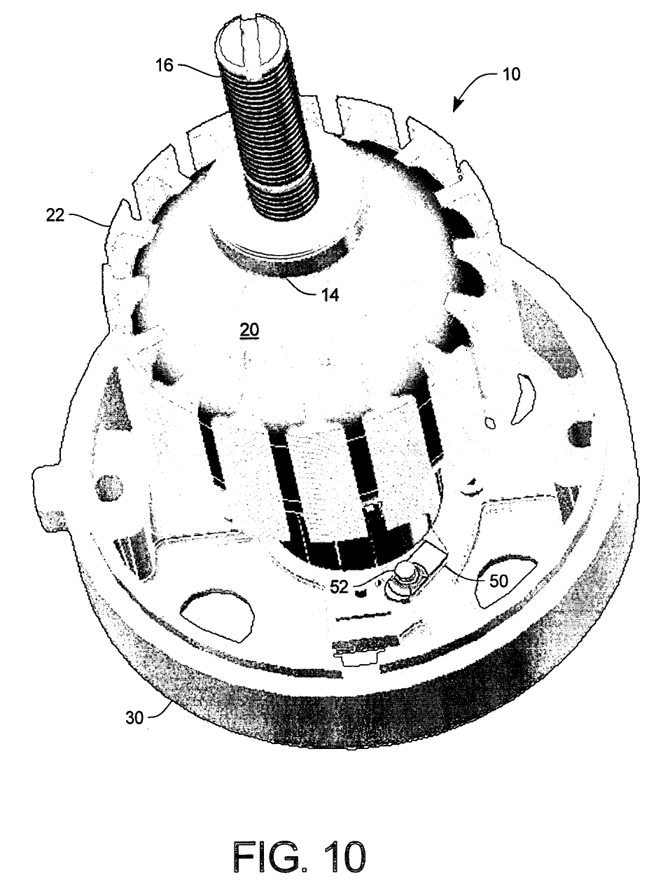

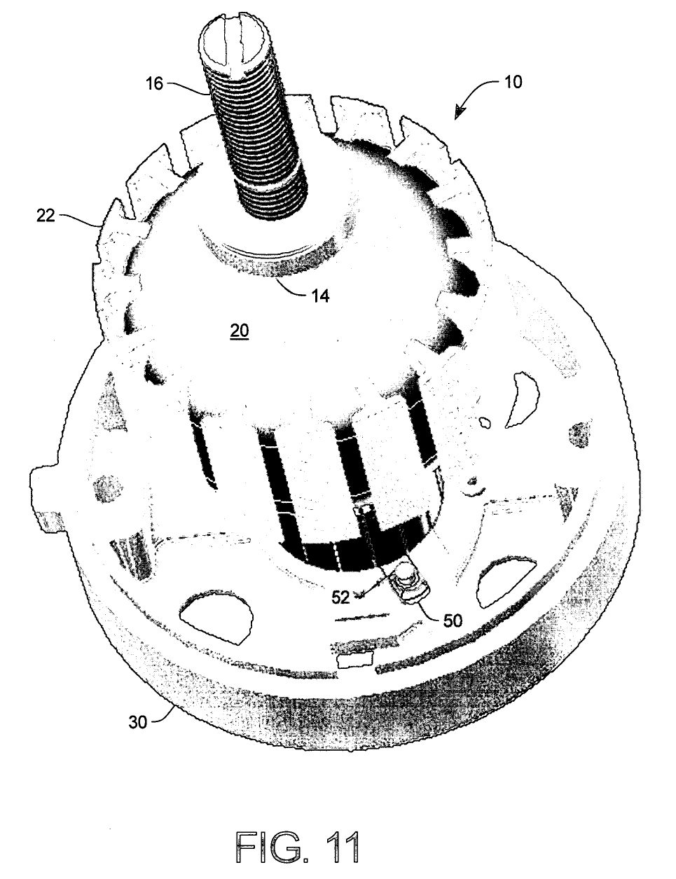

FIGS. 10 and 11 are FIGS. 8 and 9, respectively, with the addition of the rest of the armature 10.

FIG. 11 is a cross sectional view of FIG. 10 showing the bearing retention clamps 50 lying above the bearing 12 to limit the axial movement of the bearing 12 and the armature 10 attached to the bearing 12 without restricting the inner and outer races of the bearing 12 from aligning themselves in the free and loaded conditions of the motor.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method of positioning a bearing retention clamp comprising the steps of:
a) securing said bearing retention clamp with a bolt to a surface in a recessed area in an end cap, said recessed area being contiguous with a bearing bore in said end cap;
b) inserting a bearing into said bearing bore;
c) loosening said clamp from said surface; and
d) turning said bolt to tighten said clamp whereby said clamp is turned to a position to partially extend over said bearing.

2. The method set forth in claim 1 wherein in step c) said clamp is restricted in movement by a wall of said recessed area.

3. The method set forth in claim 1 wherein in step d) said clamp is pulled into a second recessed area.

4. The method set forth in claim 1 wherein in step d) the number of revolutions of said bolt is monitored to verify that said clamp is correctly positioned.

5. The method set forth in claim 1 wherein said bolt has interference threads.

6. The method set forth in claim 1 wherein said clamp at the completion of step d) does not secure said bearing in said bearing bore.

7. The method set forth in claim 1 wherein said bearing clamp is used in an electric motor, and an armature and housing are attached to said end cap before step c).

8. A bearing retention clamp receiving region in an end cap comprising:
a) a first recessed region contiguous to a bearing bore in said end cap; and
b) a second recessed region positioned at least partially within said first recessed region, said second recessed region recessed with respect to said first recessed region.

9. The bearing retention clamp receiving region set forth in claim 8 wherein said second recessed region is contiguous to said bearing bore.

10. The bearing retention clamp receiving region set forth in claim 8 wherein said second recessed region has an opening therein through said end cap.

11. A bearing retention clamp apparatus comprising:
a) a bearing retention clamp receiving region in an end cap comprising:
i) a first recessed region contiguous to a bearing bore in said end cap; and
ii) a second recessed region positioned at least partially within said first recessed region, said second recessed region recessed with respect to said first recessed region;
b) said bearing retention clamp being of a size that can fit in said first recessed region and said second recessed region; and
c) a bolt extending through said end cap and screwed into said bearing retention clamp.

12. The bearing retention clamp apparatus of claim 11 wherein said bolt has retention threads.
